(19) United States
(12) Patent Application Publication
(10) Pub. No.: US 2022/0135126 A1
(43) Pub. Date: May 5, 2022

(54) TRAILER TRACKING CONTROL

(71) Applicant: GM GLOBAL TECHNOLOGY OPERATIONS LLC, Detroit, MI (US)

(72) Inventors: Carlos E. Arreaza, Oakville (CA); Hojjat Izadi, Toronto (CA)

(21) Appl. No.: 17/089,932

(22) Filed: Nov. 5, 2020

(51) Int. Cl. B62D 13/06; B62D 15/02

(52) U.S. Cl. CPC B62D 13/06; B62D 15/025

(57) ABSTRACT

A towing configuration includes a tow vehicle and a trailer. Trailer tracking is controlled to a path of travel by an active rear steering system on the tow vehicle. The path of travel may correspond to a path traversed by the tow vehicle.

### INTRODUCTION

Many vehicles are designed to accommodate the towing or trailering of various loads, including without limitation: cargo, campers, boats, and sometimes other vehicles. Trailering presents challenges to the operator of the tow vehicle who must maneuver the tow vehicle in consideration of the pavement geometry and trailer tracking.

Active rear steering (ARS) systems are known for controlling steering angles of the rear wheels of a vehicle. Such systems are known to steer the rear wheels substantially proportionally to the steering of the front wheels within limits of the rear steering mechanism. Moreover, at low speeds the rear wheels may be steered in the direction opposite to the front wheel steering, while at high speeds the rear wheels may be steered in the same direction as the front wheel steering, though rear wheel steering direction is application specific. At low speeds, ARS may reduce the effective turning radius of the vehicle which improves maneuverability of vehicles with a longer wheelbase.

### SUMMARY

In one exemplary embodiment, an apparatus may include a trailer coupled to a tow vehicle having an active rear steering system with a controller. The controller may be configured to control the active rear steering system such that the trailer follows a predetermined path of travel.

In addition to one or more of the features described herein, the predetermined path of travel may include a path of travel corresponding to a path traversed by a predetermined point on the tow vehicle.

In addition to one or more of the features described herein, the predetermined point on the tow vehicle may include a point on a front axle of the tow vehicle.

In addition to one or more of the features described herein, the point on the front axle of the tow vehicle may include a central point on the front axle of the tow vehicle.

In addition to one or more of the features described herein, the predetermined point on the tow vehicle may include a point on a longitudinal centerline of the tow vehicle.

In addition to one or more of the features described herein, the predetermined path of travel may include a path of travel relative to a reference frame corresponding to the tow vehicle.

In addition to one or more of the features described herein, the control of the active rear steering system may be such that a predetermined point on the trailer follows the predetermined path of travel.

In addition to one or more of the features described herein, the predetermined point on the trailer may include a point on an axle of the trailer.

In addition to one or more of the features described herein, the point on the axle of the trailer may include a central point on the axle of the trailer.

In addition to one or more of the features described herein, the predetermined point on the trailer may include a point on a longitudinal centerline of the trailer.

In another exemplary embodiment, a method for controlling a path of travel of a trailer towed by a tow vehicle may include controlling an active rear steering system on the tow vehicle such that the trailer follows a predetermined path of travel.

In addition to one or more of the features described herein, the predetermined path of travel may include a path of travel corresponding to a path traversed by a predetermined point on the tow vehicle.

In addition to one or more of the features described herein, the predetermined point on the tow vehicle may include a central point on a front axle of the tow vehicle.

In addition to one or more of the features described herein, the predetermined path of travel may include a path of travel relative to a reference frame corresponding to the tow vehicle.

In addition to one or more of the features described herein, controlling an active rear steering system on the tow vehicle such that the trailer follows a predetermined path of travel may include controlling the active rear steering system such that a predetermined point on the trailer follows the predetermined path of travel.

In addition to one or more of the features described herein, the predetermined point on the trailer may include a central point on an axle of the trailer.

In yet another exemplary embodiment, a method for controlling a path of travel of a trailer towed by a tow vehicle may include determining a trailer location point on the trailer, determining a path of travel for the trailer relative to a reference frame corresponding to the tow vehicle, and controlling with an automatic rear steering system on the tow vehicle the trailer location point to the path of travel.

In addition to one or more of the features described herein, determining the trailer location point on the trailer may be based upon a trailer dimension and a hitch angle.

In addition to one or more of the features described herein, the reference frame corresponding to the tow vehicle may include a coordinate system, wherein determining the path of travel for the trailer relative to the reference frame may include updating the path of travel including transforming the path relative to position and orientation changes of the tow vehicle.

In addition to one or more of the features described herein, the trailer location point may include a point on at least one of a trailer axle and a centerline of the trailer, wherein the path of travel for the trailer may include a path traversed by a point on at least one of a front axle of the tow vehicle and the centerline of the tow vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a towing configuration including tow vehicle, trailer and control related hardware, in accordance with the present disclosure;

FIG. 2 illustrates the towing configuration of FIG. 1 in an articulated state including geometric relationships useful in control embodiments, in accordance with the present disclosure;

FIG. 3 illustrates a simplified representation of the towing configuration of FIG. 2 including an exemplary desired path for the trailer, in accordance with the present disclosure; and

FIG. 4 illustrates a flowchart of a control embodiment, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features. As used herein, control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, on vehicle networks (e.g. Controller Area Network (CAN), Local Interconnect Network (LIN) and in-plant and service-related networks. Control module functions as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module has a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

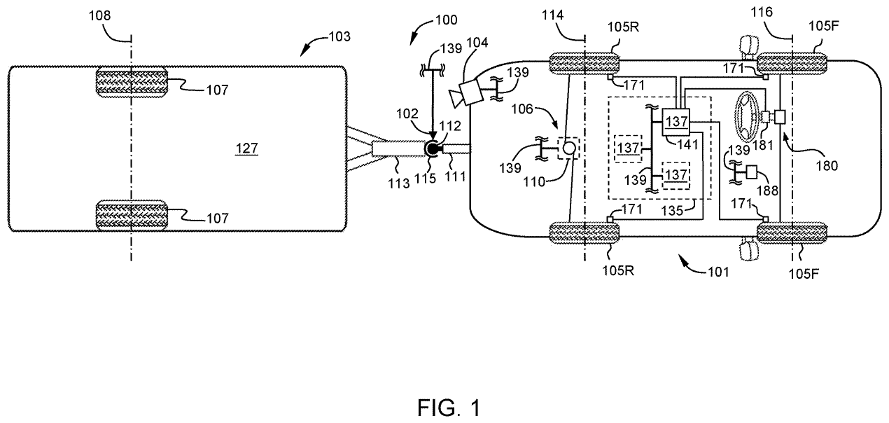

In accordance with the present disclosure, an apparatus and method for ARS control of trailer tracking a vehicle in a towing configuration is set forth herein and in the various drawings. FIG. 1 illustrates a towing configuration 100 including a tow vehicle 101 coupled to a trailer 103. Tow vehicle 101 may hereafter be referred to as vehicle 101 and is configured with an exemplary receiver hitch and ball mount 111 including a ball 112, and the trailer 103 is configured with a complementary ball socket coupler 115 at the end of a tongue 113. Alternative couplings are envisioned for towing configuration embodiments including, by way of example, pick-up bed mounted gooseneck and fifth wheel hitches. In any configuration, the trailer 103 and vehicle 101 articulate at a pivot point referred to herein as a hitch point, for example at the ball socket coupler 115 in the present embodiment. Vehicle 101 may be a four-wheel vehicle including a tire and wheel 105 at each corner. Trailer 103 is exemplified as a single-axle trailer including a tire and wheel 107 on each lateral side. As used herein, reference to wheel or tire is understood to mean a wheel and tire complement unless specifically called out differently. Exemplary trailer includes a bed 127 supported on a trailer frame which in turn is coupled by a sprung or unsprung suspension to the wheels 107. Trailer 103 is exemplary and not limiting, it being understood that alternative trailer configurations may, for example, include multiple axles (tandem axle, tri-axle, etc.), be open or closed, be adapted for hauling and dumping loads, have tilting beds, be a tow dolly supporting one axle of a towed vehicle, or have center lift mechanisms and narrow wheel base (e.g. for pontoon boats). As used herein, axle is understood to mean a pair of laterally opposing wheels on a vehicle or trailer, not necessarily including a physical axle therebetween. Thus, the vehicle 101 has a front axle 116 including the two front wheels 105F, and a rear axle 114 including the two rear wheels 105R. The trailer 103 includes one axle 108 including the wheels 107. Also as used herein, wheel may refer to a single wheel or multiple wheels at one side of an axle, for example on a dually pick-up axle or a single or multi-axle dually trailer.

Vehicle 101 may include a control system architecture 135 including a plurality of electronic control units (ECU) 137 which may be communicatively coupled via a bus structure 139 to perform control functions and information sharing, including executing control routines locally and in distributed fashion. Bus structure 139 may include a Controller Area Network (CAN), as well known to those having ordinary skill in the art. ECUs 137 may include such non-limiting examples as a powertrain control module (PCM), an engine control module (ECM), a transmission control module (TCM), a body control module (BCM), a traction control or stability control module, a cruise control module, a steering control module, a brake control module, etc. One exemplary ECU may be an ARS control module (ARSCM) 141 primarily tasked with functions related to ARS system monitoring, control and diagnostics. ECUs 137, including ARSCM 141 may be indirectly or directly connected to a variety of sensors and actuators, as well as any combination of the other ECUs (e.g., via bus structure 139).

ARSCM 141 receives a variety of information from sensors and from other ECUs for use in control of rear wheel steering of vehicle 101. Information received by ARSCM 141 may include such non limiting examples as vehicle dynamic and kinematic information such as speed, heading, steering angle, multi-axis accelerations and jerks, yaw, pitch, roll and their derivative quantities, etc. Many such quantities may be generally available over vehicle bus structure 139 originating from known vehicle sensors such as wheel speed sensors 171 at each corner of the vehicle 101, steering angle sensor 181, and yaw rate sensor 188, for example. As shown in FIG. 1, some sensors may provide information as direct inputs to ARSCM 141 while others may provide information available on bus structure 139, for example where a sensor may operate as a network node device, or where such information is generally available on the bus structure via another ECU.

Vehicle 101 includes a front axle 116 corresponding to front wheels 105F. Front wheel steering is effected by a front steering mechanism 180 which may include a steering gear and steering linkages as well known in the art. Steering input (i.e. operator interface) may be by way of a mechanical steering shaft interacting with the steering gear. Mechanical steering effort may be assisted by hydraulic or electrical devices. Steer-by-wire systems are known wherein operator steering intent is determined and, together with other information such as vehicle speed (V) and yaw rate (ω), actuates the steering rack without the need for the mechanical steering shaft interacting with the steering gear.

Vehicle 101 includes a rear axle 114 corresponding to rear wheels 105R and an ARS system. In one embodiment the ARS system may include the ARSCM 141 including control routines, various sensors and/or sensor information and rear steering mechanism 106, among other related components. Rear wheel steering is effected by rear steering mechanism 106 which may include a steering gear and steering linkages as well known in the art. Rear steering mechanism 106 may include an actuator 110 which causes the steering gear to steer the rear wheels 105R in the desired direction. In one embodiment actuator 110 may be a rotary or linear electric motor or a hydraulic actuator or combination such as an electric-over-hydraulic actuator, for example. Other actuators may be apparent to those having ordinary skill in the art. In another embodiment, the rear steering mechanism 106 may include individual actuator-at-wheel mechanisms such as independent electric actuators. Actuator 110 is communicatively coupled to ARSCM 141 either directly or via the bus structure 139 as illustrated which may provide steering angle commands to the actuator 110. Rear steering mechanism feedback, such as rear steering angle, may similarly be provided to the ARSCM 141. Among the sensor information of the ARS system is hitch angle which is defined as the angle of deviation of the centerline of the trailer 103 from alignment with the centerline of the vehicle 101. Hitch angle sensing is known to those skilled in the art and may be provided by a rotation sensor 102 such as an encoder or potentiometer or a vision system 104 including camera as non-limiting examples. Rotation sensor 102, vision system 104, or alternative hitch angle sensor may provide hitch angle information to ARSCM 141 via bus structure 139 for example.

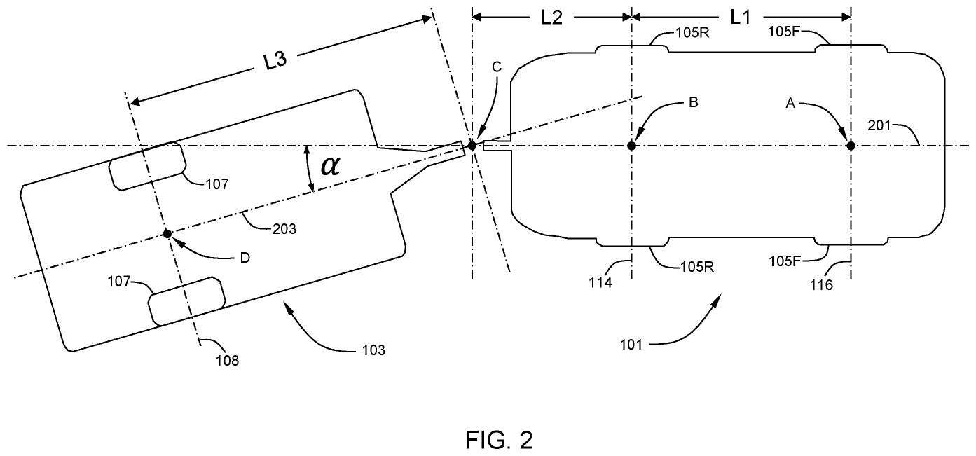

Additional reference is made to FIG. 2 wherein vehicle 101 and trailer 103 are illustrated with an articulated coupling. Various geometric relationships of the towing configuration are illustrated in FIG. 2. Vehicle 101 has a longitudinal vehicle centerline 201 and trailer 103 has a longitudinal trailer centerline 203. Each respective centerline 201, 203 passes through the towing configuration hitch point C. In the illustrated embodiment, point C corresponds to the ball 112 and ball socket coupler 115 attachment point. A hitch angle (α) is defined between the trailer centerline 203 and vehicle centerline 201 and is a measure of alignment deviation or articulation between the trailer 103 and vehicle 101. Hitch angle (α) is substantially zero as the tow configuration travels in a straight line and is non-zero as the tow configuration travels around curves or corners. The vehicle 101 front axle 116 intersects vehicle centerline 201 at point A. Point A may be referred to as the vehicle front axle center point A. The vehicle 101 rear axle 114 intersects vehicle centerline 201 at point B. Point B may be referred to as the vehicle rear axle center point B. The distance between the front axle 116 and rear axle 114 of vehicle 101, that is the distance between center points A and B, is labeled L1 and may be referred to as the vehicle wheelbase. The distance between center point B and C along the vehicle centerline 201, that is the distance between rear axle center point B and hitch point C, is labeled L2. The trailer 103 axle 108 intersects the trailer centerline 203 at point D and is the center point of the trailer 103 axle 108. Point D may be referred to as the trailer axle center point D. Trailer length is labeled L3 and corresponds to the distance between hitch point C and center point D. Point D on multi-axle trailers may correspond to either axle or a point intermediate both axles, for example.

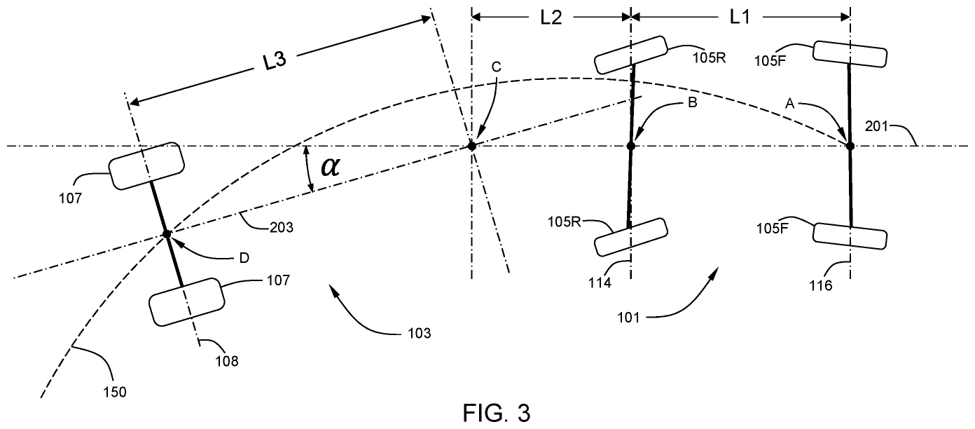

In accordance with one embodiment, FIG. 3 illustrates a trailer configuration including vehicle 101, trailer 103 and geometric relationships as set forth with respect to FIG. 2. Additionally, FIG. 3 illustrates a desired path 150 for traversal by trailer 103. Desired path 150 may be determined by the ARS system including the ARSCM 141, control routines, various sensors and/or sensor information. Preferably, the desired path 150 is determined relative to the vehicle 101 reference frame. Alternatively, the desired path 150 may be determined independent from the vehicle reference frame, for example relative to roadway or infrastructure features, including visible lane markers, radio frequency lane markers, global positioning system (GPS) and geographic information system (GIS) data, and the like. The desired path 150 for trailer 103 preferably is a clear path of travel upon the roadway. In one embodiment, the ARS system may establish a clear path of travel for the trailer 103 as a path that closely tracks the path traversed by the vehicle 101 based upon the reasonable assumption that the vehicle 101 is operated to traverse a clear path, whether by manual control by the vehicle operator or autonomously if vehicle 101 so enabled. In one embodiment, the desired path 150 is preferably determined with respect to the path traversed by the front axle 116. More preferably, the desired path 150 is determined with respect to the path traversed by the center point A of the front axle 116. In accordance with an embodiment, the vehicle 101 reference frame may be established in a two-dimensional cartesian coordinate system by designating the vehicle centerline 201 as one axis (x) (longitudinal x-axis) and the rear axle 114 as a second axis (y) (lateral y-axis). In such a reference frame, the intersection of the rear axle 114 and the vehicle centerline 201 represents the origin and corresponds to center point B of the rear axle 114 as previously set forth herein. An alternative origin location and coordinate system orientation may be utilized including, for example other origin locations along the vehicle centerline 201. Alternative coordinate systems may be apparent to those having ordinary skill in the art including, for example, a polar coordinate system.

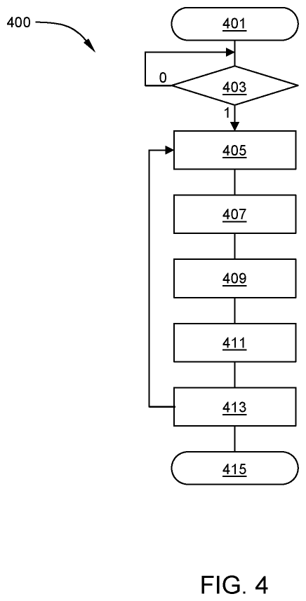

FIG. 4 illustrates an exemplary process flow for ARS control to achieve trailer tracking objectives in accordance with the present disclosure. Process 400 may be primarily implemented by ARSCM 141 through execution of computer program code. However, certain steps may require actions on the part of the vehicle 101 operator which may be interpreted through various user interfacing including, for example, interfacing with a touch screen display in the cabin of vehicle 101, or through a dialogue manager. Additionally, the computer implemented aspects of process 400 may be executed within one or more other ECUs in distributed fashion as previously disclosed and not necessarily limited execution by the ARSCM 141. Process 400 may be initiated (401) anytime the vehicle is in an operationally ready state. One or more entry conditions may be evaluated at (403) to determine whether ARS control of trailer tracking is desirable and capable. For example, the presence of a trailer may be a required condition, as may integrity of trailer wiring harness connections. The operator may also choose to selectively disable ARS control of trailer tracking. Diagnostic tests for system integrity required to proceed may also be performed. Additionally, vehicle dynamic conditions may be evaluated. For example, vehicle speed below a predetermined limit may be a required. And, a turning maneuver above some predetermined threshold steering angle may be required. Other entry conditions may be evaluated in addition to or in place of those examples set forth above. Entry conditions may be evaluated in an automated fashion through various sensor data, through operator interfacing and settings, or a combination thereof. Failure of the entry conditions (0) would result in continued monitoring for conditional changes indicating the desirability and capability of ARS control of trailer tracking. Satisfaction of the entry conditions (1) progresses to (405) whereat information such as hitch angle (α), vehicle yaw rate (ω) and vehicle speed (V) is updated.

A trailer location point is next determined at (407). The trailer location point may provide a reference for control of the trailer tracking. In the present exemplary embodiment, the trailer location point corresponds to center point D of the trailer axle 108, relative to the vehicle 101 reference frame with the origin at center point B of the rear axle 114 as described herein. Alternative trailer location points may be determined and utilized including, for example other points along the trailer axle 108 or along the trailer centerline 203. One skilled in the art will recognize that any trailer location point may be determined and utilized for the present purposes. Thus, in the present embodiment, the coordinates (x_{D}, y_{D}) of center point D of the trailer axle 108 may be determined in accordance with the following relationships:

x_{D}=L2+L3 cos(α) [1]

y_{D}=L3 sin(α) [2]

wherein
L2 is the distance between center point B of the rear axle 114 and hitch point C; and
L3 is the distance between hitch point C and the center point D of the trailer axle 108.

Next, at (409), the desired path 150 for traversal by trailer 103 may be updated. In the present embodiment the desired path 150 is determined with respect to the path traversed by center point A of the front axle 116. Alternative vehicle points may be determined and utilized for determination of the desired path 150 including, for example other points along the front axle 116 or along the vehicle centerline 201. One skilled in the art will recognize that any vehicle point may be determined and utilized for the present purposes. Thus, in accordance with the present embodiment, the desired path may be represented by points traversed by center point A of the front axle 116, and more particularly represented by those points having yet to be traversed by the trailer 103. In the present embodiment the desired path 150 is relative to the vehicle 101 reference frame preferably established in a two-dimensional cartesian coordinate system with the vehicle centerline 201 as one axis (x-axis) and the rear axle 114 as a second axis (y-axis) and the origin at the intersecting center point B as described herein. Therefore, as the vehicle 101 progresses and changes its position and orientation in space, previously determined points along the desired path 150 are transformed or mapped to the reference frame at the current position and orientation of the vehicle 101. Additionally, as the vehicle 101 progresses and new points in the desired path 150 added, historical points along the desired path 150 that have already been traversed by the trailer 103 are removed. Thus, for example, the desired path may be stored in a coordinate matrix or other such data structure and updated substantially in accordance with a first-in first-out (FIFO) approach whereby the desired path is dynamically updated. In this respect, dynamic updating of the desired path 150 includes updating points in the path and transformation of the path relative to position and orientation changes of the vehicle 101. Initially, the desired path may be populated with points exclusively along the longitudinal x-axis of the vehicle reference frame and particularly with points extending from center point A of the front axle 116 through and including center point D of the trailer axle 108. In one embodiment, a procedure for determining and dynamically updating the desired path may include calculation of the movement of the vehicle 101 reference frame in accordance with a kinematic model. Movement of the reference frame may include both angular and positional displacements or shifts. In one embodiment, the kinematic model may be a simple unicycle kinematic model as represented by the following relationships:

\dot{θ}=ω [3]

\dot{x}=V cos(θ) [4]

\dot{y}=V sin(θ) [5]

wherein
θ is the vehicle yaw angle;
ω is the vehicle yaw rate;
x is the location of center point B along the longitudinal x-axis;
y is the location of center point B along the lateral y-axis; and
V is vehicle speed.

Thus, the angular change (Δθ) in the reference frame, that is the difference between the angular orientation at current control time step (t) and the angular orientation at the previous control time step (t−1), is determined from the yaw rate (ω), which is equivalent to the rate of change in the vehicle yaw angle (θ), and the interval from the previous time step (t−1) to the current time step (t). Similarly, the positional shift (Δx, Δy) in the reference frame, that is the difference between the position at current time step (t) and the position at the previous time step (t−1), is determined from the position rates of change \dot{x} and \dot{y} and the interval from the previous time step (t−1) to the current time step (t). Movement of the vehicle 101 reference frame may be alternatively quantified, for example by dead-reckoning, relative to roadway or infrastructure features, including visible lane markers or radio frequency lane markers, or through global positioning system (GPS) and geographic information system (GIS) data.

A transformation relationship may next be used to map the historical points of the desired path 150 as follows:

$$[ \begin{matrix}x ( t ) \\ y ( t )\end{matrix} ] = [ \begin{matrix}cos ( Δθ ) & sin ( Δθ ) \\ - sin ( Δθ ) & cos ( Δθ )\end{matrix} ] [ \begin{matrix}x ( t - 1 ) - & Δ x \\ y ( t - 1 ) - & Δ y\end{matrix} ] \\ wherein [ \begin{matrix}cos ( Δθ ) & sin ( Δθ ) \\ - sin ( Δθ ) & cos ( Δθ )\end{matrix} ] \qquad [ 6 ]$$

is a rotational transformation matrix;

$$[ \begin{matrix}x ( t - 1 ) - & Δ x \\ y ( t - 1 ) - & Δ y\end{matrix} ]$$

is a prior time step point on the desired path 150 adjusted by the positional shift (Δx, Δy) in the reference frame; and

$$[ \begin{matrix}x ( t ) \\ y ( t )\end{matrix} ]$$

is the current time step point on the desired path 150 transformed to the current position and orientation of the vehicle reference frame.

One having ordinary skill in the art will recognize that the exemplary rotational transformation matrix corresponds to a clockwise rotation, whereas an alternative rotational transformation matrix of the form

$$[ \begin{matrix}cos ( Δθ ) & - sin ( Δθ ) \\ sin ( Δθ ) & cos ( Δθ )\end{matrix} ]$$

corresponds to a counterclockwise rotation. It is understood that the transformation relationship [6] may be applied to all points in the desired path 150 at each new time step whereby all prior time step positions are continually mapped to the vehicle 101 current reference frame. Thus, the entire desired path is continually updated and mapped to the vehicle reference frame at its current position and orientation. Under a FIFO approach, the oldest point in the desired path 150 may be removed from the coordinate matrix or other such data structure and the most current point added thereto. The new point may be represented by the following relationship:

$$[ \begin{matrix}x ( t ) \\ y ( t )\end{matrix} ] = [ \begin{matrix}L 1 \\ 0\end{matrix} ] \qquad [ 7 ]$$

wherein L1 is the distance between the center point B of the rear axle 114 and the center point A of the front axle 116.

ARS control calculations are made to track the trailer 103 to the desired path 150 at (411). Essentially, it is desirable that the center point D of the trailer axle 108 tracks the desired path 150 with minimal error. Thus, in one embodiment, the rear steering mechanism 106 actuator 110 may be controlled to minimize this error. One exemplary feedback controller may command actuator 110 to a steering angle setpoint δ(t) using a conventional PID controller responsive to the error e(t) between the desired path and point D to provide the steering angle setpoint δ(t). Alternatively, any appropriate controller may be employed. For example, one skilled in the art will recognize that the desired path includes a substantial set of future points along the desired path and may advantageously be used in a controller including feedforward control or compensation, or in a model predictive controller (MPC). The control setpoint, for example δ(t), is provided to the rear steering mechanism 106 actuator 110 at (413). Control time may be incremented and other controller maintenance tasks performed at (413) consistent with completion of the current control time step. Where continued rear steering mechanism 106 control for trailer tracking is desired, the process returns from (413) to (405) to repeat the control functions set forth herein. Where continued rear steering mechanism 106 control for trailer tracking is not desired, the process ends at (415).

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

Or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. An apparatus, comprising:
a trailer coupled to a tow vehicle, the tow vehicle comprising an active rear steering system including a controller; and
the controller configured to:
control the active rear steering system such that the trailer follows a predetermined path of travel.

2. The apparatus of claim 1, wherein the predetermined path of travel comprises a path of travel corresponding to a path traversed by a predetermined point on the tow vehicle.

3. The apparatus of claim 2, wherein the predetermined point on the tow vehicle comprises a point on a front axle of the tow vehicle.

4. The apparatus of claim 3, wherein the point on the front axle of the tow vehicle comprises a central point on the front axle of the tow vehicle.

5. The apparatus of claim 2, wherein the predetermined point on the tow vehicle comprises a point on a longitudinal centerline of the tow vehicle.

6. The apparatus of claim 1, wherein the predetermined path of travel comprises a path of travel relative to a reference frame corresponding to the tow vehicle.

7. The apparatus of claim 1, wherein control of the active rear steering system such that the trailer follows the predetermined path of travel comprises control such that a predetermined point on the trailer follows the predetermined path of travel.

8. The apparatus of claim 7, wherein the predetermined point on the trailer comprises a point on an axle of the trailer.

9. The apparatus of claim 8, wherein the point on the axle of the trailer comprises a central point on the axle of the trailer.

10. The apparatus of claim 7, wherein the predetermined point on the trailer comprises a point on a longitudinal centerline of the trailer.

11. A method for controlling a path of travel of a trailer towed by a tow vehicle, comprising:
controlling an active rear steering system on the tow vehicle such that the trailer follows a predetermined path of travel.

12. The method of claim 11, wherein the predetermined path of travel comprises a path of travel corresponding to a path traversed by a predetermined point on the tow vehicle.

13. The method of claim 12, wherein the predetermined point on the tow vehicle comprises a central point on a front axle of the tow vehicle.

14. The method of claim 11, wherein the predetermined path of travel comprises a path of travel relative to a reference frame corresponding to the tow vehicle.

15. The method of claim 11, wherein controlling an active rear steering system on the tow vehicle such that the trailer follows a predetermined path of travel comprises controlling the active rear steering system such that a predetermined point on the trailer follows the predetermined path of travel.

16. The method of claim 15, wherein the predetermined point on the trailer comprises a central point on an axle of the trailer.

17. A method for controlling a path of travel of a trailer towed by a tow vehicle, comprising:
determining a trailer location point on the trailer;
determining a path of travel for the trailer relative to a reference frame corresponding to the tow vehicle; and
controlling with an automatic rear steering system on the tow vehicle the trailer location point to the path of travel.

18. The method of claim 17, wherein determining the trailer location point on the trailer is based upon a trailer dimension and a hitch angle.

19. The method of claim 17, wherein the reference frame corresponding to the tow vehicle comprises a coordinate system, and wherein determining the path of travel for the trailer relative to the reference frame comprises updating the path of travel comprising transforming the path of travel relative to position and orientation changes of the tow vehicle.

20. The method of claim 17, wherein the trailer location point comprises a point on at least one of a trailer axle and a centerline of the trailer, and wherein the path of travel for the trailer comprises a path traversed by a point on at least one of a front axle of the tow vehicle and the centerline of the tow vehicle.
